(19) United States
(12) Patent Application Publication
(10) Pub. No.: US 2005/0188036 A1
(43) Pub. Date: Aug. 25, 2005

(54) E-mail filtering system and method

(75) Inventor: Masato Yasuda, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/038,520

(22) Filed: Jan. 21, 2005

(30) Foreign Application Priority Data
Jan. 21, 2004 (JP) 2004-012542

(51) Int. Cl. G06F 15/16

(52) U.S. Cl. 709/206

(57) ABSTRACT

An e-mail filtering system determines whether a received e-mail is an unsolicited e-mail or a possible unsolicited e-mail. If the received e-mail is an unsolicited e-mail, a URL contained in the received e-mail is registered in a memory. If the received e-mail is a possible unsolicited e-mail, a search is made through the memory for a registered URL corresponding to a URL contained in the e-mail. If the corresponding registered URL is detected, the possible unsolicited e-mail is identified as an unsolicited e-mail. In response to receipt of an e-mail, its source IP address or a URL contained in it is used to identify it as a possible unsolicited e-mail and a count value is incremented, which is reset to zero if the time following receipt of a possible unsolicited e-mail has lapsed a predetermined interval. The possible unsolicited e-mail is identified as an unsolicited e-mail when the count value exceeds a threshold.

### BACKGROUND OF THE INVENTION

1. Field of the Invention

The present invention relates to an electronic mail filtering system and method for filtering unsolicited electronic mails.

2. Description of the Related Art

An e-mail filtering system are used in imposing restrictions (such as blocking or delay) on unsolicited e-mails, known as spam e-mails, in order to prevent users from being annoyed with and to prevent communications networks from being overloaded with massive junk e-mails transmitted from commercial firms for advertisement of their goods and services.

In the e-mail filtering system shown and described in Japanese Patent Publication P2003-173314A, incoming e-mails are intercepted by a line interface and temporarily stored in a buffer. An e-mail manager maintains a list of identities, such as “spam words”, of many unsolicited or unwanted e-mails in a memory. When an e-mail is intercepted and stored in the memory, the manager compares its source identity with each of the source identities for a match. If there is a match, the e-mail is recognized as a spam and a restriction is imposed on the stored e-mail. If no match is detected, the e-mail is forwarded from the buffer to its destination. The user at the destination determines if the e-mail is acceptable. If not, the source identity and header information of the rejected e-mail are registered in the memory. If the number of denied e-mails transmitted from a single source exceeds a threshold, the source identity and a spam word of the e-mails are registered in the memory.

However, since the user has to make a decision on the intercepted e-mails whether to accept or reject, the communications network is still subjected to a flow of useless traffic. Furthermore, the prior art system is incapable of avoiding unwanted e-mails if their text is altered by the spammer.

Therefore, there exists a need for an e-mail filtering system and method for reducing the network traffic of e-mails that are suspected of spam mails and relieving the users from the burden of checking intercepted e-mails. Additionally, there exists a need for automatically storing source identities of spam e-mails.

### SUMMARY OF THE INVENTION

It is therefore an object of the present invention to provide an e-mail filtering system and method for reducing useless network traffic caused by massive unsolicited e-mails.

According to a first aspect of the present invention, the present invention is based on a search for a URL contained in the text of a received e-mail linking to a Web site for saving the detected URL in a store as an identity of a subsequent e-mail transmitted from the same spam source.

In this aspect, the e-mail filtering system comprises a store for maintaining registered URLs, decision mechanism for determining whether a received e-mail is an unsolicited e-mail or a possible unsolicited e-mail, and registration mechanism for making a registration of a URL containing in the received e-mail into the store if the received e-mail is determined to be an unsolicited e-mail in the store. The decision mechanism further determines whether the possible unsolicited e-mail contains a URL which is registered in the store and identifies the possible unsolicited e-mail as an unsolicited e-mail if the possible unsolicited e-mail is determined to contain the registered URL.

According to a second aspect of the present invention, the present invention is based on the detection of the traffic volume of e-mails transmitted from a possible spam source in a given period of time for identifying the e-mails as spam when the detected traffic volume exceeds a threshold. In the second aspect, the e-mail filtering system comprises processing means for identifying, as a possible unsolicited e-mail, a received e-mail by using one of the source IP address of the e-mail and a URL contained in the text of the e-mail, incrementing a count value in response to receipt of the possible unsolicited e-mail, resetting the count value to zero if the time following a receipt of the possible unsolicited e-mail has lapsed a predetermined interval, and identifying the possible unsolicited e-mail as an unsolicited e-mail if the count value is higher than a threshold value. In one preferred embodiment, the processing means identifies a received e-mail as a possible unsolicited e-mail by the source IP address of the e-mail. In another preferred embodiment, the processing means detects a URL contained in a received e-mail and identifies it as a possible unsolicited e-mail by the detected URL. If the count value is higher than the threshold value, the URL contained in the possible unsolicited e-mail is registered in a store and the possible unsolicited e-mail is identified as an unsolicited e-mail. If the count value is lower than the threshold value, the processing means determines whether the possible unsolicited e-mail contains a URL registered in the first store, and if the possible unsolicited e-mail is determined to contain the registered URL, the possible unsolicited e-mail is identified as an unsolicited e-mail. Preferably, spam words are further registered in the store. If the count value is lower than the threshold value, the processing means determines whether the possible unsolicited e-mail contains a spam word and a URL which are registered in the store. If the possible unsolicited e-mail is determined to contain the registered URL, the possible unsolicited e-mail is identified as an unsolicited e-mail, and if the possible unsolicited e-mail is determined not to contain the registered URL but contain the registered spam word, a URL contained in the possible unsolicited e-mail is registered in the store, and the possible unsolicited e-mail is identified as an unsolicited e-mail.

In one embodiment, a second store is provided for maintaining a whitelist of non-spam URLs. The second store is searched for a non-spam URL corresponding to a URL contained in the possible unsolicited e-mail. If the corresponding non-spam URL is detected in the second store, the registration of URL is inhibited. In a further embodiment, the registered URLs are selected from a plurality of candidate URLs. The processing means makes a registration of a URL contained a possible unsolicited e-mail in a second store as a candidate URL. The candidate URLs are accessed from an external source, selected and then registered.

According to a third aspect of the present invention, there is provided a method of filtering unsolicited e-mails comprising the steps of (a) determining whether a received e-mail is an unsolicited e-mail or a possible unsolicited e-mail, (b) if the received e-mail is an unsolicited e-mail, making a registration of a URL contained in the received e-mail into a store if the received e-mail is determined to be an unsolicited e-mail, (c) if the received e-mail is determined to be a possible unsolicited e-mail, determining whether the possible unsolicited e-mail contains a URL which is registered in the store and identifying the possible unsolicited e-mail as an unsolicited e-mail if the possible unsolicited e-mail is determined to contain the registered URL.

According to a fourth aspect, the present invention provides a method of filtering unsolicited e-mails comprising the steps of identifying, as a possible unsolicited e-mail, a received e-mail by using one of the source IP address of the e-mail and a URL contained in the text of the e-mail, incrementing a count value in response to each of received e-mails each being identified as a possible unsolicited e-mail, resetting the count value to zero if the time following a receipt of an e-mail identified as a possible unsolicited e-mail has lapsed a predetermined interval, and identifying the possible unsolicited e-mail as an unsolicited e-mail if the count value is higher than a threshold value.

According to a fifth aspect of the present invention, there is provided a mobile terminal wirelessly connected to a mobile communication network, comprising a store for maintaining registered URLs, decision mechanism for determining whether an e-mail received from the network is an unsolicited e-mail or a possible unsolicited e-mail, and registration mechanism for making a registration of a URL containing in the received e-mail into the store if the received e-mail is determined to be an unsolicited e-mail. The decision mechanism further determines whether the possible unsolicited e-mail contains a URL which is registered in the store and identifies the possible unsolicited e-mail as an unsolicited e-mail if the registered URL is contained in the possible unsolicited e-mail.

According to a sixth aspect of the present invention, there is provided a mobile terminal wirelessly connected to a mobile communication network, comprising processing means for identifying, as a possible unsolicited e-mail, an e-mail received from the network by using one of the source IP address of the e-mail and a URL contained in the text of the e-mail, incrementing a count value in response to receipt of the possible unsolicited e-mail, resetting the count value to zero if the time following a receipt of the possible unsolicited e-mail has lapsed a predetermined interval, and identifying the possible unsolicited e-mail as an unsolicited e-mail if the count value is higher than a threshold value.

### BRIEF DESCRIPTION OF THE DRAWINGS

The present invention will be described in detail further with reference to the following drawings, in which:

FIG. 1 is a block diagram of an e-mail filtering system according to a first embodiment of the present invention;

FIG. 2 is a flowchart of the operation of the control processor of FIG. 1;

FIG. 3 is a timing diagram for describing the operation of the present invention;

FIG. 4 is a block diagram of an e-mail filtering system according to a second embodiment of the present invention;

FIG. 5 is a flowchart of the operation of the control processor of FIG. 4;

FIG. 6 is a block diagram of an e-mail filtering system according to a third embodiment of the present invention;

FIG. 7 is a flowchart of the operation of the control processor of FIG. 6;

FIG. 8 is a flowchart of the operation of an external manual controller associated with the block diagram of FIG. 6;

FIG. 9 is a block diagram of an e-mail filtering system according to a fourth embodiment of the present invention;

FIG. 10 is a flowchart of the operation of the control processor of FIG. 9;

FIG. 11 is a flowchart of the operation of the control processor of FIG. 4 modified according to the second embodiment of the invention; and

FIG. 12 is a flowchart of the operation of the control processor of FIG. 6 modified according to the third embodiment of the invention.

### DETAILED DESCRIPTION

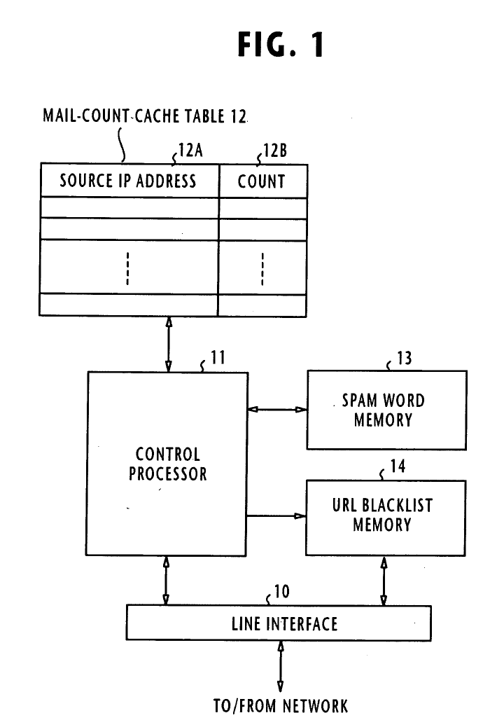

Referring now to FIG. 1, there is shown an electronic mail filtering system according to a first embodiment of the present invention. The system comprises a control processor 11 connected to a communications network such as the Internet through a line interface 10. Control processor 11 operates on a programmed logic such as FPGA (Field Programmable Gate Array). Associated with the control processor 11 are a mail-count cache table 12, a spam word memory 13 and a URL blacklist memory 14, which is also coupled to the line interface 10 so that it can be accessed from a proxy server, not shown.

Line interface 10 intercepts e-mails transmitted through the network to destination computer terminals or mobile terminals and extracts a string of letters indicating the source IP address and the text from the received e-mails and supplies the extracted letter string to the control processor 11. If the received e-mailza is a spam, it is highly likely that the extracted text contains a URL starting with the letters “http (hyper text transfer protocol)” that links to a Web site associated with a spammer.

Mail-count cache table 12 consists of a plurality of entries each having a source IP address field 12A and a count field 12B. Each entry has a predetermined timeout period. When the timeout period expires, the entry is deleted from the table. Therefore, table entries created by normal e-mails will be deleted from the cache table 12 before their count value reaches the threshold, leaving those entries in the cache table 12 whose corresponding sources continue to send e-mails at intervals relatively short to the timeout period.

Spam word memory 13 maintains a list of words as a reference for making a determination whether a received e-mail is a normal e-mail or an unsolicited e-mail. Additionally, the spam word memory 13 stores a plurality of URLs (Uniform Resource Locators), which will be detected in the texts of spam mails as a link to Web sites, as “registered” URLs to be used for imposing restrictions on forthcoming spam mails.

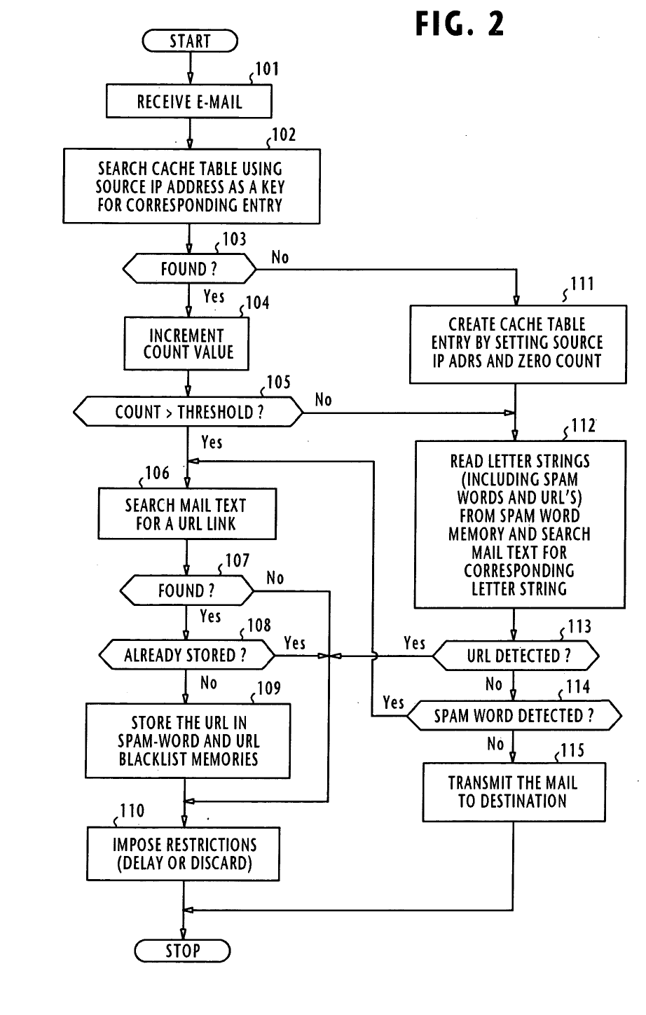

The operation of the control processor 11 proceeds according to the flowchart of FIG. 2.

When an e-mail is intercepted by the line interface 10 (step 101), the control processor 11 receives the source IP address and text of the e-mail from the interface 10 and makes a search through the cache table 12 for detecting a corresponding entry using the source IP address as a search key (step 102). If a corresponding entry is not found in the mail-count cache table 12 (step 103), the processor proceeds from step 103 to step 111 to create a new entry in the mail-count cache table 12 by setting the source IP address in the address field 12A of the created entry and a zero-count value in the count field 12B, and then proceeds to step 112. The e-mail registered in the mail-count cache table 12 is identified as a possible unsolicited e-mail.

If a corresponding entry is found in the cache table 12, it is determined that the received e-mail is identified as a possible unsolicited e-mail. In this case, the decision at step 103 is affirmative and flow proceeds to step 104 to increment the count value of the corresponding entry by a predetermined amount. At step 105, the incremented count value is compared to a threshold and a decision is made whether the threshold is exceeded or not. If the threshold is not exceeded, flow proceeds from step 105 to step 112.

At step 112, letter strings are retrieved from the spam word memory 13, and a search is made through the mail text for detecting a letter string that corresponds to one of these letter strings and the processor proceeds to decision steps 113 and 114. The retrieved letter strings include spam words initially set in the spam word memory 13 and URL's which are registered as the operation of processor 11 proceeds.

If a registered URL is not detected, but a registered spam word is detected, the decision at step 113 is negative, but affirmative at step 114. Flow proceeds from step 114 to step 106 to search through the text of the current e-mail for a URL that links to a Web site, which may be operated by a spammer. If a URL is found in the mail text, the decision at step 107 is affirmative and flow proceeds to step 108 to check to see if the detected URL is one that is already stored in the spam word and URL blacklist memories 13 and 14. If the decision is negative, flow proceeds from step 108 to step 109 to store the URL in the spam word memory 13 and the URL blacklist memory 14, and flow proceeds to step 110 to impose restrictions on the e-mail. Restrictions are also imposed on the e-mail if no URL is detected at step 107.

If the decision at step 113 is affirmative, it is determined that the URL contained in the received e-mail is already registered, and flow proceeds to step 110 to impose restrictions (delay or discard) on the received e-mail.

If the decisions at steps 113 and 114 are both negative, flow proceeds to step 115 to reformulate an e-mail and transmit it to the destination as a normal e-mail.

If a large number of e-mails are transmitted from the same spam source to the same destination, it is likely that these e-mails are already registered in the cache table 12 as possible unsolicited e-mails and the processor 11 increments their count value in the corresponding cache table entry.

If it is determined that the count value of a possible unsolicited e-mail exceeds the threshold (step 105), the decision at step 105 is affirmative and the e-mail is identified as an unsolicited e-mail. Flow proceeds to step 106 to make a search through the mail text for a URL link to a Web site. If a URL is detected in the mail text at step 107 and if this URL is determined at step 108 to be not already registered, the detected URL is added to the spam word memory 13 and the URL blacklist memory 14 as a new URL.

As a result, if the count value is below the threshold (step 105) and a previously registered URL is detected in the text of a newly arrived e-mail, the decision at step 114 is affirmative. In this case, the e-mail is identified as a spam and restrictions are imposed on this mail at step 110. Thus, the count value of a cache table entry exceeds the threshold only if the incoming e-mails are transmitted from the same source at short intervals. Once the threshold is exceeded, all e-mails from the spam source are examined for URLs to be additionally registered in the memories 13 and 14 (steps 106 to 109) and then treated as spam mails (step 110).

If a previously registered URL is not detected in the text of a newly arrived e-mail, the decision at step 114 is negative, indicating that the e-mail is eligible for transmission to the destination at step 115.

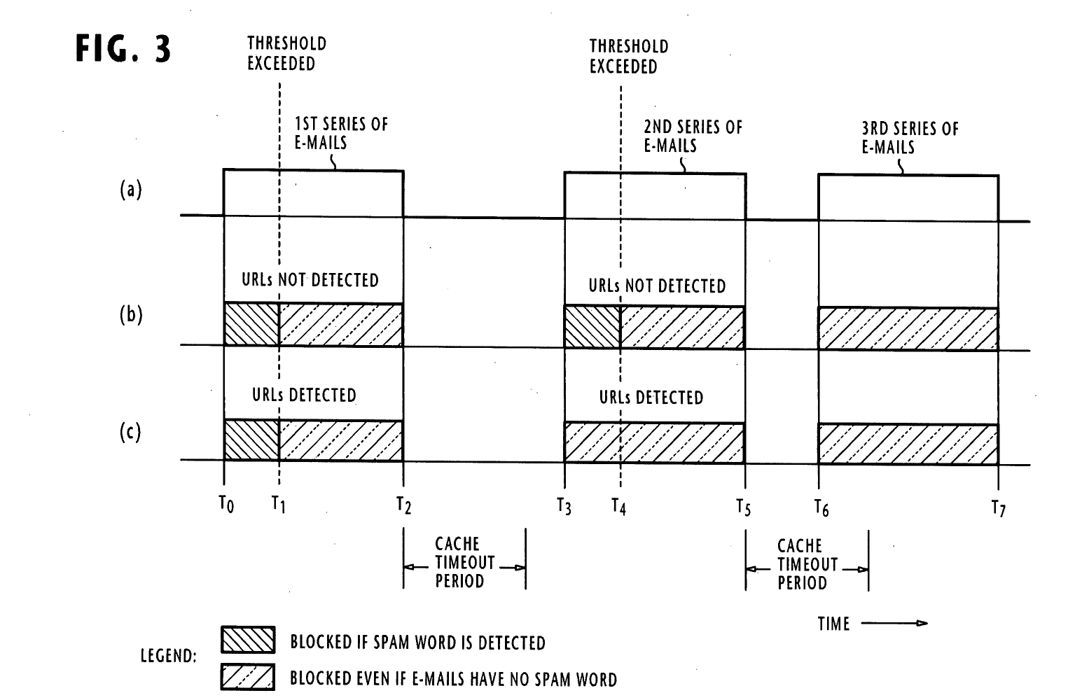

For a better understanding of the present invention, reference is made to the timing diagram of FIG. 3.

As shown in part (a) of FIG. 3, assume that a given spam source transmits a large number of unwanted e-mails to a given destination, so that a first series of numerous e-mails arrives during T₀ and T₂ and the threshold is exceeded at time T₁, a second series of e-mails arrives during T₃ and T₅ after the cache timer that is triggered in response to the last e-mail of the first series has expired, and a third series of e-mails arrives during T₆ and T₇ after the cache timer that is triggered in response to the last e-mail of the second series is still running.

Two simplified cases are considered as illustrated in parts (b) and (c) of FIG. 3. In the first case URLs are not detected in the first and second series of e-mails and in the second case URLs are detected in the first and second series of e-mails.

In the first case shown in part (b) of FIG. 3, if a spam word is detected in intercepted e-mails during the period T₀ and T₁, at step 113 (FIG. 2), restrictions are imposed on such e-mails. Otherwise, the intercepted e-mails are retransmitted as normal e-mails to the destination. During the subsequent period T₁ and T₂, restrictions are imposed on all received e-mails even if they do not contain a spam word. Since the cache timer of the entry of the source IP address has been expired (i.e., the count value of this spam source is reset to zero) and since no URLs are detected in the first series of e-mails, the e-mails that arrive during a period following time T₃ are treated as spam only if a spam word is detected at step 113 until the count value exceeds the threshold at time T₄. Otherwise, the e-mails intercepted during the period T₃ and T₄ are retransmitted as normal e-mails to the destination. All e-mails intercepted during the period T₄ and T₅ are treated as spam and restrictions are imposed even if they do not contain a spam word. During the period T₆ to T₇, since the threshold was exceeded at time T₄, all the forthcoming e-mails are treated as spam even if they do not contain a spam word or even if no URL was registered during the previous period T₃ to T₅, as long as the cache timer of the spam source entry is running.

In the second case shown in part (c) of FIG. 3, if a spam word is detected in intercepted e-mails during the period T₀ and T₁, at step 113 (FIG. 2), restrictions are imposed on such e-mails. Otherwise, the intercepted e-mails are retransmitted as normal e-mails to the destination. During the subsequent period T₁, and T₂, restrictions are imposed on all received e-mails even if they do not contain a spam word. Although the cache timer of the entry of the source IP address has been expired, URLs were detected in the first series of e-mails and registered during the period T₀ and T₂. Thus, the e-mails that arrive during the period T₃ and T₅ are treated as spam even if they do not contain a spam word in their mail text. During the period T₆ to T₇, since the threshold was exceeded at time T₄ and the cache timer is still running, all the forthcoming e-mails are treated as spam even if they do not contain a spam word.

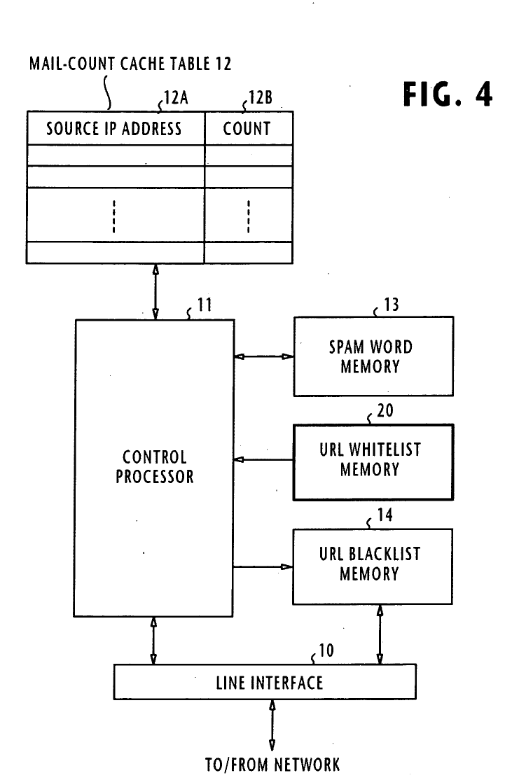

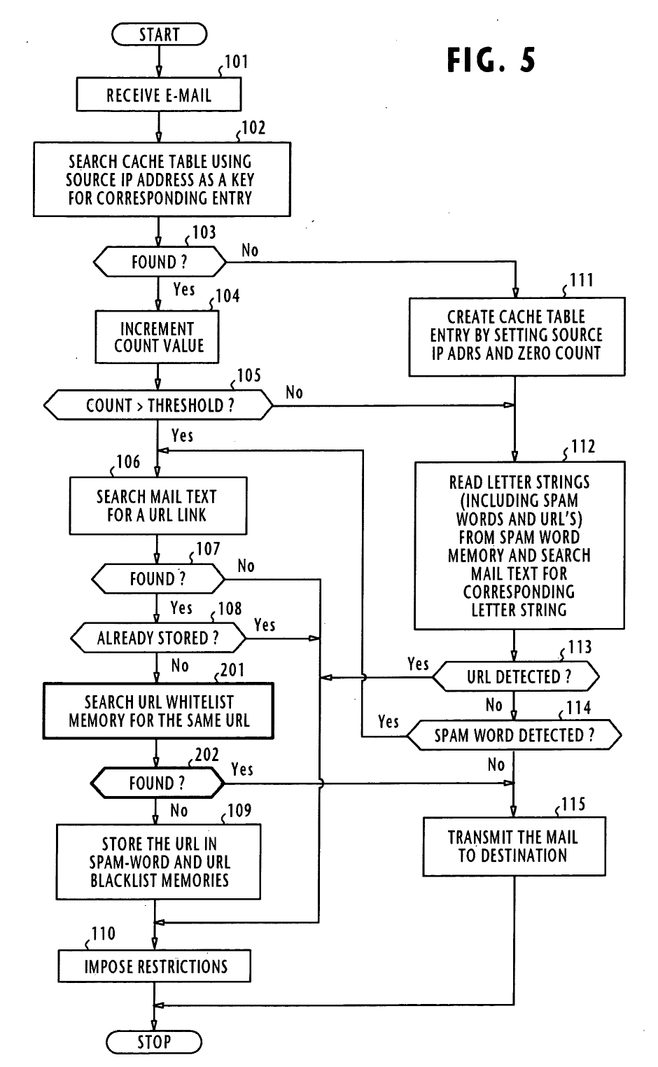

FIG. 4 is a block diagram of a second embodiment of the present invention and FIG. 5 is a flowchart of the operation of the processor of FIG. 4. This embodiment is a modification of the first embodiment of the present invention. In FIGS. 4 and 5, parts corresponding in significance to those in FIGS. 1 and 2 are marked with the same numerals and the description thereof is not repeated.

The e-mail filtering system of FIG. 4 differs from the previous embodiment by the inclusion of a URL whitelist memory 20 with which the control processor 11 is associated. URL whitelist memory 20 maintains a list of URLs that the user does not want to be included in the URL blacklist. The massive amount of e-mails that a user receives in a short period of time may sometimes contain a type of messages beneficial to the user such as e-mail magazines. In such e-mail magazines, a large amount of e-mails are transmitted from a single IP address source. To avoid such e-mails from being treated as spam, the control processor 11 operates according to the flowchart of FIG. 5, which differs from the flowchart of FIG. 2 by the inclusion of steps 201 and 202 following decision step 108.

When the decision at step 108 is negative for a given e-mail, indicating that a URL is detected in the mail text but it is still not registered in the memories 13 and 14, flow proceeds to step 201 to make a search through the URL whitelist memory 20 for a URL identical to the URL detected in the mail text by using the detected URL as a search key, and proceeds to decision step 202. If the same URL is detected in the whitelist memory 20, the decision at step 202 is affirmative and flow proceeds to step 115 to transmit the given e-mail to the destination. If the decision is negative at step 202, flow proceeds to step 109 to impose restrictions. Note that the whitelist memory 20 can also be created by source mail address entries, instead of URL entries.

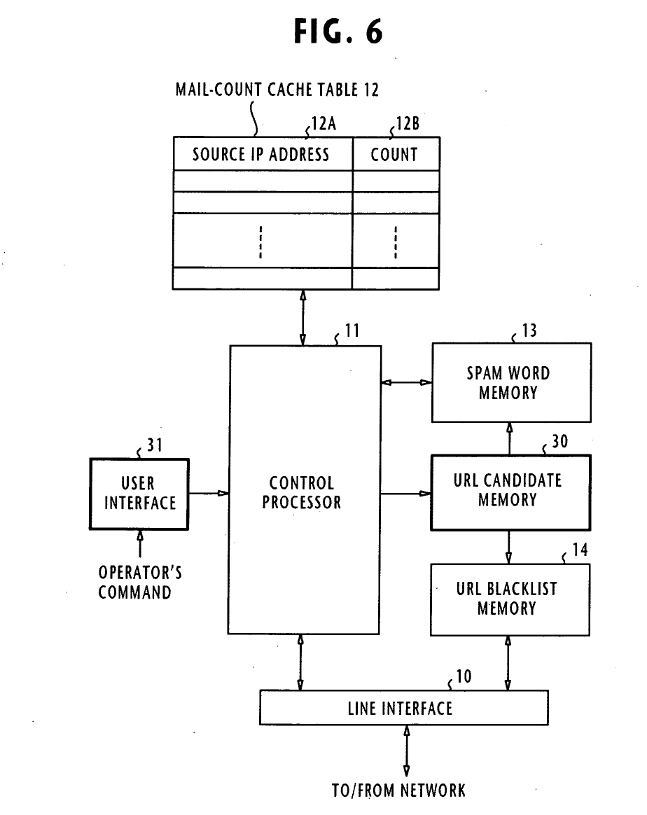

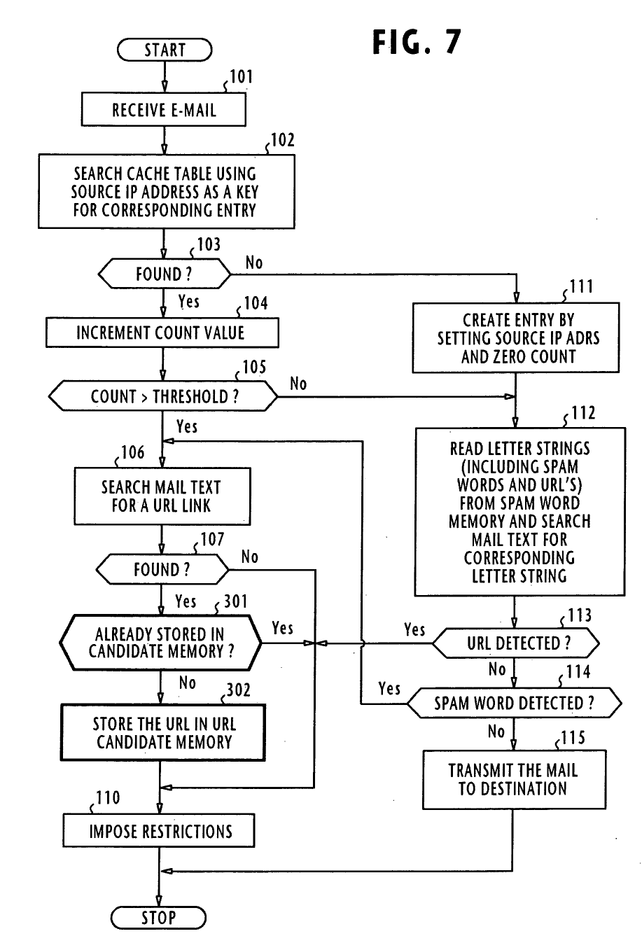

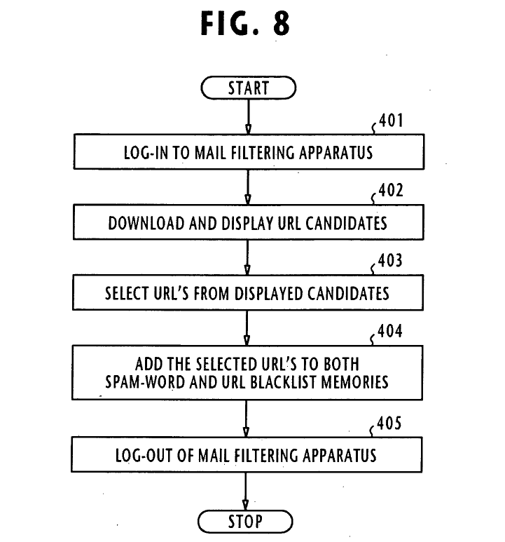

FIG. 6 is a block diagram of a third embodiment of the e-mail filtering system and FIG. 7 is a flowchart of the operation of the control processor of FIG. 6. In the third embodiment, the control processor 11 is further associated with a URL candidate memory 30 and a user interface 31 through which operator's command is entered. In the URL candidate memory 30, candidate URLs are temporarily stored to be inspected by the user to allow decision to be made as to whether or not a candidate URL is to be registered in the spam word memory 13 and the blacklist memory 14. FIG. 8 is a flowchart of the operation of a user's command system when an operator makes a decision on the stored candidate URLs as will be described later.

In FIG. 7, steps 301 and 302 are provided, instead of steps 108 and 109 of FIG. 2. Following the affirmative decision of step 107, indicating that a URL is detected in the text of an e-mail, the control processor 11 checks to see if the detected URL is already stored in the candidate memory 30. If this is the case, flow proceeds to step 110 to impose restrictions on the e-mail. If the detected URL is not already stored in the candidate memory 30, the processor proceeds to step 302 to store the detected URL in the candidate memory 30 before it executes step 110.

In FIG. 8, the operator logs in into the e-mail filtering system of FIG. 6 through the interface 31 to access the candidate memory 30 (step 401). At step 402, the URL candidates are downloaded from the candidate memory 30 and displayed on the operator's screen. Then the operator selects URLs from the displayed candidates (step 403) and adds the selected URLs to the spam word memory 13 and the URL blacklist memory 15 (step 404). At step 405, the operator logs out of the e-mail filtering system.

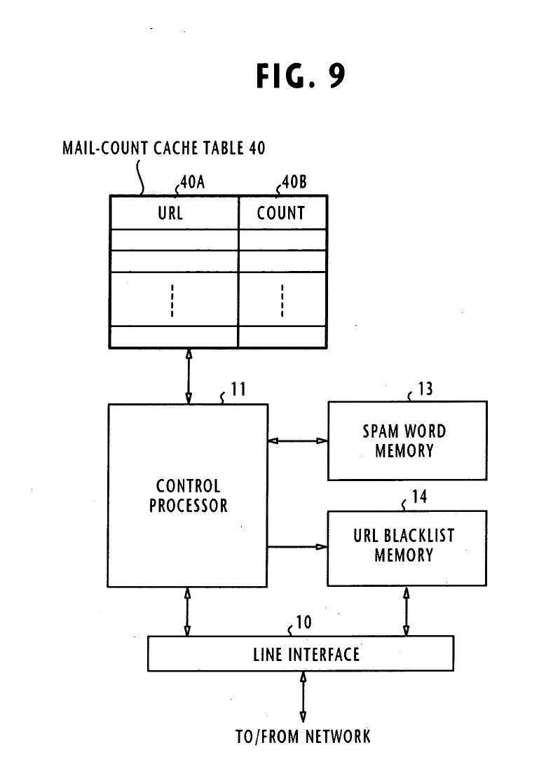

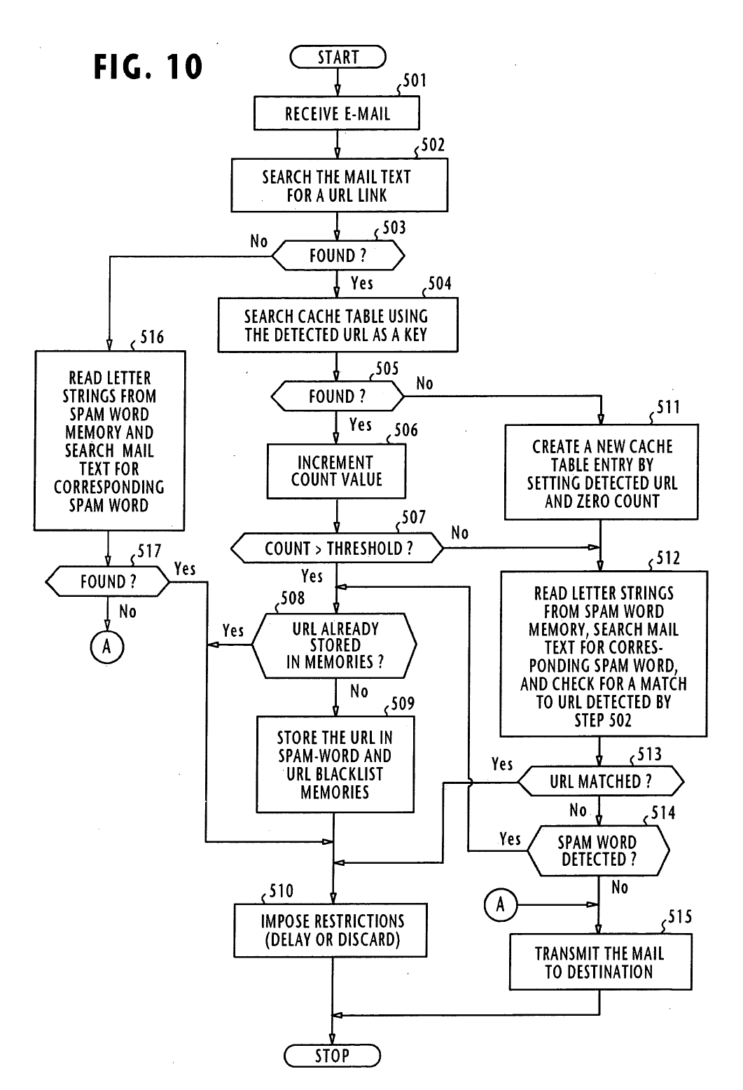

In the previous embodiments, source IP addresses are used to create an entry in the mail-count cache table 12. The present invention could be modified as shown in FIG. 9 as a fourth embodiment in which URLs are used to create an entry in a mail-count cache table 40, instead of the source IP address. As illustrated, the mail-count cache table 40 has a plurality of entries each having a URL field 40A and a count field 40B. FIG. 10 is a flowchart of the operation of the control processor 11 of FIG. 9.

In FIG. 10, when an e-mail is intercepted by the line interface 10 (FIG. 9) at step 501, the control processor 11 receives a string of letters from the line interface 10 indicating the text of the e-mail and makes a search through the letter string of the mail text for a URL link to a Web site, i.e., a letter string starting with the letters “http” (steps 502, 503).

If a URL link is not detected in the mail text, the decision at step 503 is negative and the control processor proceeds to step 516 to read spam words from the spam word memory 13 and makes a search through the mail text for a spam word that corresponds to one of the spam words registered in the spam word memory 13.

If such a spam word is detected in the spam word memory, the decision at step 517 is affirmative and flow proceeds to step 510 to impose restrictions on the e-mail. If such a spam word is not detected, it is determined that the e-mail is a normal mail and flow proceeds from step 517 to step 515 to transmit the e-mail to the destination.

If a URL link is detected in the mail text, the decision at step 503 is affirmative and flow proceeds to steps 504, 505 to make a search through the mail-count cache table 40 for an entry containing a URL identical to the one detected in the mail text by using the detected URL as a search key and determines whether or not such an entry is detected.

If a corresponding entry is not detected in the cache table 40, flow proceeds from step 505 to step 511 to create a new entry in the cache table 40 by setting the detected URL in the URL field 40A of the entry and a zero count value in its count field 40B. Control processor 11 proceeds to step 512 to read letter strings (including spam words and URLs) from the spam word memory 13 and makes a search through the mail text for a corresponding spam word and checks for a match to the URL which was detected at step 502 to identify the received e-mail as a possible unsolicited e-mail in the cache table 12.

If no corresponding spam word or URL is detected, the processor makes negative decisions at steps 513 and 514 and proceeds to step 515 to transmit the e-mail to the destination.

If the URL detected at step 502 does not match a registered URL but a registered spam word is detected in the search, the processor proceeds from step 514 to decision step 508 to check to see if the URL detected at step 502 is already stored in the spam word memory 13 and the blacklist memory 14. If not, flow proceeds to step 509 to store the detected URL in the memories 13 and 14 and then proceeds to step 510 to impose restrictions on the e-mail. If the URL detected at step 502 is already stored in the memories 13, 14, flow proceeds from step 508 to step 510 to impose restrictions on the e-mail.

If the URL detected at step 502 matches a registered URL, flow proceeds from step 513 to step 510 to impose restrictions on the e-mail. If the decisions at steps 513 and 514 are both negative, flow proceeds to step 515 to transmit the e-mail to the destination.

If it is determined at step 505 that an entry corresponding to the detected URL is found in the cache table 40, flow proceeds from step 505 to step 506 to increment the count value of the corresponding entry by a predetermined amount. Then, the count value is compared to a threshold at step 507. If the count value is below the threshold, the control processor proceeds to step 512 to perform a registered URL check on the e-mail. If the count value exceeds the threshold, the processor proceeds to step 508 to check for the registration of the detected URL. If no registration is made on the detected URL, flow proceeds to step 509 to store the detected URL in the spam word memory 13 and the blacklist memory 14.

Since the cache table entries are created in response to URL links contained in e-mails, the fourth embodiment is advantageous for applications in which copies of an advertisement message are transmitted simultaneously from many Web sites, instead of from a single source, since the count value increases in proportion to the total number of spam mails transmitted from the multiple sources. If source IP addresses are used to create cache table entries as described in the previous embodiments, the individual number of spam mails transmitted from each spam source is low. Hence it is likely that the threshold is not exceeded by the count value of any of the multiple spam sources.

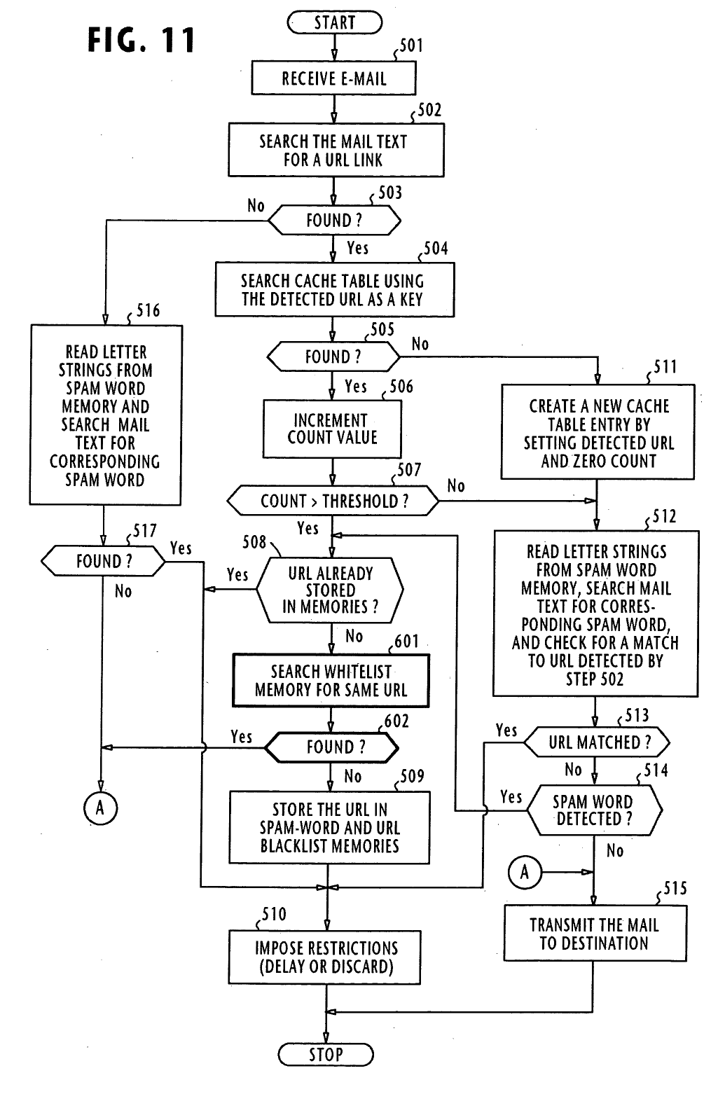

FIG. 11 is a flowchart of the operation of the second embodiment (whitelist memory) of FIG. 4 modified according to the fourth embodiment. FIG. 11 differs from FIG. 10 in that it includes steps 601 and 602 between steps 508 and 509 of FIG. 10.

When the decision at step 508 is negative for a given e-mail, indicating that a URL is detected in the mail text but it is still not registered in the memories 13, 14, flow proceeds to step 601 to make a search through the URL whitelist memory 20 for detecting a URL identical to the URL detected in the mail text by using the detected URL as a search key, and proceeds to decision step 602. If the same URL is detected in the whitelist memory 20, the decision at step 602 is affirmative and flow proceeds to step 515 to transmit the given e-mail to the destination. If the decision is negative at step 602, flow proceeds to step 509 to impose restrictions.

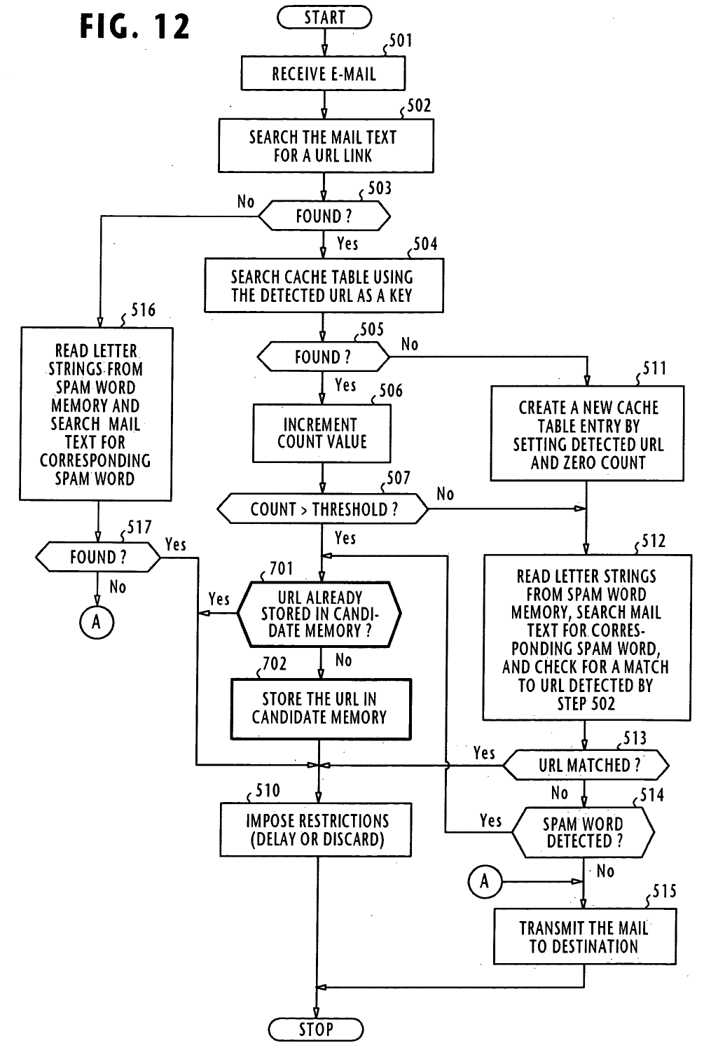

FIG. 12 is a flowchart of the operation of the third embodiment (URL candidate memory) of FIG. 6 modified according to the fourth embodiment. FIG. 12 differs from FIG. 10 in that it includes steps 701 and 702, instead of steps 508 and 509 of FIG. 10.

Following the affirmative decision of step 507, indicating that a URL is detected in the text of a received e-mail, the control processor 11 proceeds to sep 701 to check to see if the detected URL is already stored in the candidate memory 30. If this is the case, flow proceeds to step 510 to impose restrictions on the e-mail. If the detected URL is not already stored in the candidate memory 30, the processor proceeds to step 702 to store the detected URL in the candidate memory 30 before it executes step 510.

The e-mail filtering system of the present invention may be implemented in a mobile terminal wirelessly connected to a mobile communication network. In this case, the wireless interface of the mobile terminal is used as the line interface 10 and the controller 11, the mail-count cache table 12, the spam word memory 13 and the URL blacklist memory 14 of FIG. 1, for example, are installed in the mobile terminal. The e-mail filtering systems of other embodiments shown in FIGS. 5, 7, 10 to 12 can also be installed in the mobile terminal.

1. An e-mail filtering system comprising:
a first store for maintaining registered URLs;
decision mechanism for determining whether a received e-mail is an unsolicited e-mail or a possible unsolicited e-mail; and
registration mechanism for making a registration of a URL contained in the received e-mail into said first store if the received e-mail is determined to be an unsolicited e-mail,
said decision mechanism determining whether the received e-mail contains a URL registered in said first store if the received e-mail is determined to be a possible unsolicited e-mail and identifying the received e-mail as an unsolicited e-mail if the received e-mail is determined to contain said registered URL.

2. The e-mail filtering system of claim 1, wherein said decision mechanism identifies a received e-mail as a possible unsolicited e-mail by using the source IP address of the e-mail, increments a count value in response to each of received e-mails identified as a possible unsolicited e-mail, resets said count value to zero if the time following a receipt of the possible unsolicited e-mail has lapsed a predetermined interval, and changes said possible unsolicited e-mail to said unsolicited e-mail if said count value is higher than a threshold value.

3. The e-mail filtering system of claim 1, wherein said decision mechanism identifies a received e-mail as a possible unsolicited e-mail by using a URL contained in the text of the e-mail, increments a count value in response to each of received e-mails identified as a possible unsolicited e-mail, resets said count value to zero if the time following a receipt of the possible unsolicited e-mail has lapsed a predetermined interval, and identifies said possible unsolicited e-mail as an unsolicited e-mail if said count value is higher than a threshold value.

4. The e-mail filtering system of claim 1, 2 or 3, further comprising a second store for maintaining a whitelist of URLs, and wherein said registration mechanism makes a search through said whitelist for an URL which corresponds to the URL detected in the text of said unsolicited e-mail and makes no registration of the detected URL in said first store if the detected URL corresponds to the URL of the whitelist.

5. The e-mail filtering system of claim 1, 2 or 3, further comprising a second store for maintaining candidate URLs, and wherein said registration mechanism makes a registration of the detected URL in said second store as one of said candidate URLs, and wherein said second store is accessible from an external source which is configured to select a candidate URL from said second store and set the selected candidate URL into said first store as one of the registered URLs.

6. The e-mail filtering system of claim 1, further comprises restriction mechanism for imposing a restriction said unsolicited e-mail.

7. The e-mail filtering system of any of claims 1, further comprising a second store, wherein said registered URLs are maintained as a blacklist of URLs in said second store, said third store being arranged to be accessible from an external source.

8. The e-mail filtering system of claim 1, 2 or 3, wherein said first store further maintains a plurality of registered spam words, and wherein said decision mechanism makes a search through said first store for a registered spam word corresponding to a word contained in said possible unsolicited e-mail if said count value is lower than said threshold value, and identifies the possible unsolicited e-mail as an unsolicited e-mail if said corresponding registered spam word is detected in said first store.

9. An e-mail filtering system comprising:
processing means for identifying, as a possible unsolicited e-mail, a received e-mail by using one of the source IP address of the e-mail and a URL contained in the text of the e-mail, incrementing a count value in response to receipt of said possible unsolicited e-mail, resetting said count value to zero if the time following a receipt of said possible unsolicited e-mail has lapsed a predetermined interval, and identifying the possible unsolicited e-mail as an unsolicited e-mail if said count value is higher than a threshold value.

10. The e-mail filtering system of claim 9, further comprising a cache table having a plurality of entries, each of the entries being removed from the cache table when the time after the entry is created has lapsed said predetermined interval,
wherein said processing means is configured to:
make a search through said cache table for an entry corresponding to a received e-mail by using the source IP address of the received e-mail as a search key,
if no corresponding entry is detected in said cache table, create an entry in said cache table by setting said source IP address and a predetermined count value in the created entry, and
if a corresponding entry is detected, increment the count value of the corresponding entry by a predetermined amount.

11. The e-mail filtering system of claim 9, further comprising a cache table having a plurality of entries, each of the entries being removed from the cache table when the time after the entry is created has lapsed said predetermined interval, and
wherein said processing means is configured to:
make a search through said cache table for an entry corresponding to a received e-mail by using a URL contained in the e-mail as a search key,
if no corresponding entry is detected in said cache table, create an entry in said cache table by setting said Linking URL and a predetermined count value in the created entry, and
if a corresponding entry is detected in said cache table, increment the count value of the corresponding entry by a predetermined amount.

12. The e-mail filtering system of claim 9, further comprising a first store for maintaining registered URLs, wherein said processing means is configured to:
identify a received e-mail as a possible unsolicited e-mail by the source IP address of the e-mail,
if said count value is higher than said threshold value, make a registration of a URL contained in the possible unsolicited e-mail into said first store and identify the possible unsolicited e-mail as an unsolicited e-mail,
if said count value is lower than said threshold value, determine whether said possible unsolicited e-mail contains a URL registered in said first store, and
if said possible unsolicited e-mail is determined to contain the registered URL, identify the possible unsolicited e-mail as an unsolicited e-mail.

13. The e-mail filtering system of claim 9, further comprising a first store for maintaining registered spam words and registered URLs,
wherein said processing means is configured to:
identify a received e-mail as a possible unsolicited e-mail by the source IP address of the received e-mail,
if said count value is higher than said threshold value, make a registration of a URL contained in said possible unsolicited e-mail into said first store and identify said possible unsolicited e-mail as an unsolicited e-mail,
if said count value is lower than said threshold value, determine whether said possible unsolicited e-mail contains a spam word and a URL which are registered in said first store,
if said possible unsolicited e-mail is determined to contain the registered URL, identify said possible unsolicited e-mail as an unsolicited e-mail, and
if said possible unsolicited e-mail is determined not to contain said registered URL but contain the registered spam word, make a registration of a URL contained in the possible unsolicited e-mail into said first store, and identify said possible unsolicited e-mail as an unsolicited e-mail.

14. The e-mail filtering system of claim 9, further comprising a first store for maintaining registered URLs, wherein said processing means is configured to:
detect a URL contained in the received e-mail and identify the received e-mail as a possible unsolicited e-mail by the detected URL,
if said count value is higher than said threshold value, make a registration of the detected URL into said first store and identify the possible unsolicited e-mail as an unsolicited e-mail,
if said count value is lower than said threshold value, determine whether said possible unsolicited e-mail contains a URL registered in said first store, and
if said possible unsolicited e-mail is determined to contain the registered URL, identify the possible unsolicited e-mail as an unsolicited e-mail.

15. The e-mail filtering system of claim 9, further comprising a first store for maintaining registered spam words and registered URLs,
wherein said processing means is configured to:
detect a URL contained in the received e-mail and identify the received e-mail as a possible unsolicited e-mail by the detected URL,
if said count value is higher than said threshold value, make a registration of the detected URL into said first store and identify the possible unsolicited e-mail as an unsolicited e-mail,
if said count value is lower than said threshold value, determine whether said possible unsolicited e-mail contains a spam word and a URL which are registered in said first store,
if said possible unsolicited e-mail is determined to contain the registered URL, identify the possible unsolicited e-mail as an unsolicited e-mail, and
if said possible unsolicited e-mail is determined not to contain said registered URL but contain said registered spam word, make a registration of said detected URL in said first store, and identify the possible unsolicited e-mail as an unsolicited e-mail.

16. The e-mail filtering system of any of claims 12 to 15, further comprising a second store for maintaining a whitelist of non-spam URLs,
wherein said processing means is configured to:
make a search through said second store for a non-spam URL corresponding to a URL contained in said possible unsolicited e-mail, and
if said corresponding non-spam URL is detected in said second store, inhibit said registration of said URL in said first store.

17. The e-mail filtering system of any of claims 12 to 15, further comprising a second store for maintaining candidate URLs, wherein the URLs registered in said first store are URLs selected from a plurality of candidate URLs, and wherein said processing means is configured to make a registration of a URL contained said possible unsolicited e-mail in said second store as a candidate URL, further comprising means for accessing said second store for manually selecting a candidate URL and storing the selected candidate URL into said first store as a registered URL.

18. The e-mail filtering system of any of claims 12 to 15, wherein said processing means is configured to impose restriction on the unsolicited e-mail.

19. The e-mail filtering system of any of claims 12 to 15, further comprising a second store for maintaining registered URLs in a blacklist of spam sources, said second store being arranged so that the blacklist in said second store is accessible from an external source.

20. A method of filtering e-mails, comprising the steps of:
a) determining whether a received e-mail is an unsolicited e-mail or a possible unsolicited e-mail;
b) if the received e-mail is determined to be an unsolicited e-mail, making a registration of a URL contained in the unsolicited e-mail into a first store;
c) if the received e-mail is determined to be a possible unsolicited e-mail, determining whether the possible unsolicited e-mail contains a URL registered in said first store; and
d) if the possible unsolicited e-mail is determined to contain the registered URL, identifying said possible unsolicited e-mail as an unsolicited e-mail.

21. The method of claim 20, wherein step (a) comprises the steps of:
identifying a received e-mail as a possible unsolicited e-mail by using the source IP address of the e-mail;
incrementing a count value in response to each of received e-mails identified as a possible unsolicited e-mail;
resetting said count value to zero if the time following a receipt of the possible unsolicited e-mail has lapsed a predetermined interval; and
identifying said possible unsolicited e-mail as an unsolicited e-mail if said count value is higher than a threshold value.

22. The method of claim 20, wherein step (a) comprises the steps of:
identifying a received e-mail as a possible unsolicited e-mail by using a URL contained in the received e-mail,
incrementing a count value in response to each of received e-mails identified as a possible unsolicited e-mail;
resetting said count value to zero if the time following a receipt of the possible unsolicited e-mail has lapsed a predetermined interval; and
identifying said possible unsolicited e-mail as an unsolicited e-mail if said count value is higher than a threshold value.

23. The method of claim 20, 21 or 22, further comprising the steps of:
maintaining a whitelist of URLs;
determining whether a received e-mail contains a URL maintained in said whitelist; and
inhibiting said registration of the URL in said first store if the received e-mail is determined to contain said URL maintained in said whitelist.

24. The method of claim 20, 21 or 22, further comprising the steps of:
making a registration of the detected URL in a second store as one of a plurality of candidate URLs; and
allowing an external source to select one of said candidate URLs from aid second store and set the selected candidate URL into said first store as one of the registered URLs.

25. The method of claim 20, 21 or 22, further comprises the step of imposing a restriction said unsolicited e-mail.

26. The method of claim 20, 21 or 22, further comprising the steps of storing said registered URLs as a blacklist of URLs, and allowing said blacklist to be accessed from an external source.

27. A method of filtering e-mails, comprising the steps of:
identifying, as a possible unsolicited e-mail, a received e-mail by using one of the source IP address of the e-mail and a URL contained in the text of the e-mail;
incrementing a count value in response to each of received e-mails each being identified as a possible unsolicited e-mail;
resetting said count value to zero if the time following a receipt of an e-mail identified as a possible unsolicited e-mail has lapsed a predetermined interval; and
identifying the possible unsolicited e-mail as an unsolicited e-mail if said count value is higher than a threshold value.

28. The method of claim 27, wherein a cache table is provided having a plurality of entries, each of the entries being removed from the cache table when the time after the entry is created has lapsed said predetermined interval, further comprising the steps of:
making a search through said cache table for an entry corresponding to a received e-mail by using the source IP address of the received e-mail as a search key;
if no corresponding entry is detected in said cache table, creating an entry in said cache table by setting said source IP address and a predetermined count value in the created entry; and
if a corresponding entry is detected, incrementing the count value of the corresponding entry by a predetermined amount.

29. The method of claim 27, wherein a cache table is provided having a plurality of entries, each of the entries being removed from the cache table when the time after the entry is created has lapsed said predetermined interval, further comprising the steps of:
making a search through said cache table for an entry corresponding to a received e-mail by using a linking URL contained in the text of the e-mail as a search key;
if no corresponding entry is detected in said cache table, creating an entry in said cache table by setting said linking URL and a predetermined count value in the created entry; and
if a corresponding entry is detected in said cache table, incrementing the count value of the corresponding entry by a predetermined amount.

30. The method of claim 27, wherein a first store is provided for maintaining registered URLs, further comprising the steps of:
a) identifying a received e-mail as a possible unsolicited e-mail by the source IP address of the e-mail;
b) if said count value is higher than said threshold value, making a registration of a URL contained in the possible unsolicited e-mail into said first store and identifying said possible unsolicited e-mail as an unsolicited e-mail;
c) if said count value is lower than said threshold value, determining whether said possible unsolicited e-mail contains a URL registered in said first store; and
d) if said possible unsolicited e-mail is determined to contain the registered URL, identifying said possible unsolicited e-mail as an unsolicited e-mail.

31. The method of claim 27, wherein a first store is provided for maintaining registered spam words and registered URLs, further comprising the steps of:
a) identifying a received e-mail as a possible unsolicited e-mail by the source IP address of the received e-mail;
b) if said count value is higher than said threshold value, making a registration of a URL contained in said possible unsolicited e-mail into said first store and identifying said possible unsolicited e-mail as an unsolicited e-mail;
c) if said count value is lower than said threshold value, determining whether said possible unsolicited e-mail contains a spam word and a URL which are registered in said first store;
d) if said possible unsolicited e-mail is determined not to contain said URL but contain said registered spam word, making a registration of a URL contained in the possible unsolicited e-mail in said first store; and identifying said possible unsolicited e-mail as an unsolicited e-mail; and
e) if said possible unsolicited e-mail is determined to contain said registered URL, identifying said possible unsolicited e-mail as an unsolicited e-mail.

32. The method of claim 27, wherein a first store is provided for maintaining registered URLs, further comprising the steps of:
a) detecting a URL in a received e-mail and identifying the received e-mail as a possible unsolicited e-mail by the detected URL;
b) if said count value is higher than said threshold value, make a registration of the detected URL in said first store, and identifying the possible unsolicited e-mail as an unsolicited e-mail;
c) if said count value is lower than said threshold value, determining whether said possible unsolicited e-mail contains a URL registered in said first store; and
d) if said possible unsolicited e-mail is determined to contain said registered URL, identifying the possible unsolicited e-mail as an unsolicited e-mail.

33. The method of claim 27, wherein a first store is provided for maintaining registered spam words and registered URLs, further comprising the steps of:
a) detecting a URL in a received e-mail, and identifying the received e-mail as a possible unsolicited e-mail by the detected URL;
b) if said count value is higher than said threshold value, making a registration of the detected URL in said first store, and identifying the possible unsolicited e-mail as an unsolicited e-mail;
c) if said count value is lower than said threshold value, determining whether said possible unsolicited e-mail contains a spam word and a URL which are registered in said first store;
d) if said possible unsolicited e-mail is determined not to contain said registered URL but contain said registered spam word, making a registration of said detected URL in said first store, and identifying the possible unsolicited e-mail as an unsolicited e-mail; and
e) if the possible unsolicited e-mail is determined to contain said registered URL, identifying the possible unsolicited e-mail as an unsolicited e-mail.

34. The method of any of claims 30 to 33, wherein a second store is provided for maintaining a whitelist of non-spam URLs, further comprising the steps of:
determining whether said possible unsolicited e-mail contains a URL maintained in said whitelist; and
if said possible unsolicited e-mail is determined to contain said URL maintained in said whitelist, inhibiting said registration of the URL in said first store.

35. The method of any of claims 30 to 33, wherein a second store is provided for maintaining candidate URLs, and wherein the URLs registered in said first store are URLs selected from said candidate URLs, wherein step (b) comprises the steps of:
making a registration of the detected linking URL in said second store as a candidate URL; and
selecting a candidate URL from said maintained candidate URLs and storing the selected candidate URL into said first store as a registered URL.

36. The method of any of claims 30 to 33, further comprising the step of imposing restriction on the unsolicited e-mail.

37. The method of any of claims 30 to 33, wherein a second store is provided for maintaining registered URLs in a blacklist of spam sources, further comprising the step of accessing the blacklist in said second store from an external source.

38. A computer-readable storage medium containing a program for filtering e-mails, said program comprising the steps of:
a) determining whether a received e-mail is an unsolicited e-mail or a possible unsolicited e-mail;
b) if the received e-mail is determined to be an unsolicited e-mail, making a registration of a URL contained in the unsolicited e-mail into a first store;
c) if the received e-mail is determined to be a possible unsolicited e-mail, determining whether the possible unsolicited e-mail contains a URL registered in said first store; and
d) if the possible unsolicited e-mail is determined to contain the registered URL, identifying said possible unsolicited e-mail as an unsolicited e-mail.

39. The computer-readable storage medium of claim 38, wherein step (a) comprises the steps of:
identifying a received e-mail as a possible unsolicited e-mail by using the source IP address of the e-mail;
incrementing a count value in response to each of received e-mails identified as a possible unsolicited e-mail;
resetting said count value to zero if the time following a receipt of the possible unsolicited e-mail has lapsed a predetermined interval; and
identifying said possible unsolicited e-mail as an unsolicited e-mail if said count value is higher than a threshold value.

40. The computer-readable storage medium of claim 38, wherein step (a) comprises the steps of:
identifying a received e-mail as a possible unsolicited e-mail by using a URL contained in the received e-mail;
incrementing a count value in response to each of received e-mails identified as a possible unsolicited e-mail;
resetting said count value to zero if the time following a receipt of the possible unsolicited e-mail has lapsed a predetermined interval; and
identifying said possible unsolicited e-mail as an unsolicited e-mail if said count value is higher than a threshold value.

41. The computer-readable storage medium of claim 38, 39 or 40, further comprising the steps of:
maintaining a whitelist of URLs;
determining whether a received e-mail contains a URL maintained in said whitelist; and
inhibiting said registration of the URL in said first store if the received e-mail is determined to contain said URL maintained in said whitelist.

42. The computer-readable storage medium of claim 38, 39 or 40, further comprising the steps of:
making a registration of the detected URL in a second store as one of a plurality of candidate URLs; and
allowing an external source to select one of said candidate URLs from aid second store and set the selected candidate URL into said first store as one of the registered URLs.

43. The computer-readable storage medium of claim 38, 39 or 40, further comprises the step of imposing a restriction on said unsolicited e-mail.

44. The computer-readable storage medium of claim 38, 39 or 40, further comprising the steps of storing said registered URLs as a blacklist of URLs, and allowing said blacklist to be accessed from an external source.

45. A computer-readable storage medium containing a program for filtering e-mails, said program comprising the steps of:
identifying, as a possible unsolicited e-mail, a received e-mail by using one of the source IP address of the e-mail and a URL contained in the text of the e-mail;
incrementing a count value in response to each of received e-mails each being identified as a possible unsolicited e-mail;
resetting said count value to zero if the time following a receipt of an e-mail identified as a possible unsolicited e-mail has lapsed a predetermined interval; and
identifying the possible unsolicited e-mail as an unsolicited e-mail if said count value is higher than a threshold value.

46. The computer-readable storage medium of claim 45, wherein a cache table is provided having a plurality of entries, each of the entries being removed from the cache table when the time after the entry is created has lapsed said predetermined interval, further comprising the steps of:
making a search through said cache table for an entry corresponding to a received e-mail by using the source IP address of the received e-mail as a search key;
if no corresponding entry is detected in said cache table, creating an entry in said cache table by setting said source IP address and a predetermined count value in the created entry; and
if a corresponding entry is detected, incrementing the count value of the corresponding entry by a predetermined amount.

47. The computer-readable storage medium of claim 45, wherein a cache table is provided having a plurality of entries, each of the entries being removed from the cache table when the time after the entry is created has lapsed said predetermined interval, further comprising the steps of:
making a search through said cache table for an entry corresponding to a received e-mail by using a linking URL contained in the text of the e-mail as a search key;
if no corresponding entry is detected in said cache table, creating an entry in said cache table by setting said linking URL and a predetermined count value in the created entry; and
if a corresponding entry is detected in said cache table, incrementing the count value of the corresponding entry by a predetermined amount.

48. The computer-readable storage medium of claim 45, wherein a first store is provided for maintaining registered URLs, further comprising the steps of:
a) identifying a received e-mail as a possible unsolicited e-mail by the source IP address of the e-mail;
b) if said count value is higher than said threshold value, making a registration of a URL contained in the possible unsolicited e-mail into said first store and identifying said possible unsolicited e-mail as an unsolicited e-mail;
c) if said count value is lower than said threshold value, determining whether said possible unsolicited e-mail contains a URL registered in said first store; and
d) if said possible unsolicited e-mail is determined to contain the registered URL, identifying said possible unsolicited e-mail as an unsolicited e-mail.

49. The computer-readable storage medium of claim 45, wherein a first store is provided for maintaining registered spam words and registered URLs, further comprising the steps of:
a) identifying a received e-mail as a possible unsolicited e-mail by the source IP address of the received e-mail;
b) if said count value is higher than said threshold value, making a registration of a URL contained in said possible unsolicited e-mail into said first store and identifying said possible unsolicited e-mail as an unsolicited e-mail;
c) if said count value is lower than said threshold value, determining whether said possible unsolicited e-mail contains a spam word and a URL which are registered in said first store;
d) if said possible unsolicited e-mail is determined not to contain said URL but contain said registered spam word, making a registration of a URL contained in the possible unsolicited e-mail in said first store; and identifying said possible unsolicited e-mail as an unsolicited e-mail; and
e) if said possible unsolicited e-mail is determined to contain said registered URL, identifying said possible unsolicited e-mail as an unsolicited e-mail.

50. The computer-readable storage medium of claim 45, wherein a first store is provided for maintaining registered URLs, further comprising the steps of:
a) detecting a URL in a received e-mail and identifying the received e-mail as a possible unsolicited e-mail by the detected URL;
b) if said count value is higher than said threshold value, making a registration of the detected URL in said first store, and identifying the possible unsolicited e-mail as an unsolicited e-mail;
c) if said count value is lower than said threshold value, determining whether said possible unsolicited e-mail contains a URL registered in said first store; and
d) if said possible unsolicited e-mail is determined to contain said registered URL, identifying the possible unsolicited e-mail as an unsolicited e-mail.

51. The computer-readable storage medium of claim 45, wherein a first store is provided for maintaining registered spam words and registered URLs, further comprising the steps of:
a) detecting a URL in a received e-mail, and identifying the received e-mail as a possible unsolicited e-mail by the detected URL;
b) if said count value is higher than said threshold value, making a registration of the detected URL in said first store, and identifying the possible unsolicited e-mail as an unsolicited e-mail;
c) if said count value is lower than said threshold value, determining whether said possible unsolicited e-mail contains a spam word and a URL which are registered in said first store;
d) if said possible unsolicited e-mail is determined not to contain said registered URL but contain said registered spam word, making a registration of said detected URL in said first store, and identifying the possible unsolicited e-mail as an unsolicited e-mail; and
e) if the possible unsolicited e-mail is determined to contain said registered URL, identifying the possible unsolicited e-mail as an unsolicited e-mail.

52. The computer-readable storage medium of any of claims 48 to 51, wherein a second store is provided for maintaining a whitelist of non-spam URLs, further comprising the steps of:
determining whether said possible unsolicited e-mail contains a URL maintained in said whitelist; and
if said possible unsolicited e-mail is determined to contain said URL maintained in said whitelist, inhibiting said registration of the URL in said first store.

53. The computer-readable storage medium of any of claims 48 to 51, wherein a second store is provided for maintaining candidate URLs, and wherein the URLs registered in said first store are URLs selected from said candidate URLs, wherein step (b) comprises the steps of:
making a registration of the detected linking URL in said second store as a candidate URL; and
selecting a candidate URL from said maintained candidate URLs and storing the selected candidate URL into said first store as a registered URL.

54. The computer-readable storage medium of any of claims 48 to 51, further comprising the step of imposing restriction on the unsolicited e-mail.

55. The computer-readable storage medium of any of claims 48 to 51, wherein a second store is provided for maintaining registered URLs in a blacklist of spam sources, further comprising the step of accessing the blacklist in said second store from an external source.

56. A mobile terminal wirelessly connected to a mobile communication network, comprising:
a store for maintaining registered URLs;
decision mechanism for determining whether an e-mail received from said network is an unsolicited e-mail or a possible unsolicited e-mail; and
registration mechanism for making a search through the text of the received e-mail for a URL linking to a Web site if the received e-mail is determined as an unsolicited e-mail and making a registration of the detected URL in said store,
said decision mechanism making a search through the text of the possible unsolicited e-mail for a URL corresponding to a URL registered in said store and identifying said possible unsolicited e-mail as an unsolicited e-mail if said corresponding URL is detected.

57. The mobile terminal of claim 56, wherein said decision mechanism identifies a received e-mail as a possible unsolicited e-mail by using the source IP address of the e-mail, increments a count value in response to each of received e-mails identified as a possible unsolicited e-mail, resets said count value to zero if the time following a receipt of the possible unsolicited e-mail has lapsed a predetermined interval, and identifies said possible unsolicited e-mail as an unsolicited e-mail if said count value is higher than a threshold value.

58. The mobile terminal of claim 56, wherein said decision mechanism identifies a received e-mail as a possible unsolicited e-mail by using a URL contained in the text of the e-mail, increments a count value in response to each of received e-mails identified as a possible unsolicited e-mail, resets said count value to zero if the time following a receipt of the possible unsolicited e-mail has lapsed a predetermined interval, and identifies said possible unsolicited e-mail as an unsolicited e-mail if said count value is higher than a threshold value.

59. A mobile terminal wirelessly connected to a mobile communication network, comprising:
processing means for identifying, as a possible unsolicited e-mail, an e-mail received from said network by using one of the source IP address of the e-mail and a URL contained in the text of the e-mail, incrementing a count value in response to receipt of said possible unsolicited e-mail, resetting said count value to zero if the time following a receipt of said possible unsolicited e-mail has lapsed a predetermined interval, and identifying the possible unsolicited e-mail as an unsolicited e-mail if said count value is higher than a threshold value.

60. The mobile terminal of claim 59, further comprising a store for maintaining registered URLs, wherein said processing means is configured to:
identify a received e-mail as a possible unsolicited e-mail by the source IP address of the e-mail,
if said count value is lower than said threshold value, make a registration of a URL contained in said possible unsolicited e-mail into said store and identify said possible unsolicited e-mail as an unsolicited e-mail,
if said count value is lower than said threshold value, determine whether said possible unsolicited e-mail contains a URL registered in said store, and
if the possible unsolicited e-mail is determined to contain said registered URL, identify said possible unsolicited e-mail as an unsolicited e-mail.

61. The mobile terminal of claim 59, further comprising a store for maintaining registered URLs;
wherein said processing means is configured to:
make a search through the text of a received e-mail for detecting a URL linking to a Web site, and identify the received e-mail as a possible unsolicited e-mail by the detected URL,
if said count value is higher than said threshold value, make a registration of a URL contained in said possible unsolicited e-mail into said store, and identify the possible unsolicited e-mail as an unsolicited e-mail;
if said count value is lower than said threshold value, determine whether said possible unsolicited e-mail contains a URL registered in said store; and
if said possible unsolicited e-mail is determined to contain said registered URL, identify the possible unsolicited e-mail as an unsolicited e-mail.
